(19) United States
(12) Patent Application Publication
(10) Pub. No.: US 2026/0350870 A1
(43) Pub. Date: Nov. 5, 2026

(54) IMAGE PROCESSING APPARATUS, IMAGE PROCESSING METHOD, AND PROGRAM

(71) Applicant: Sony Interactive Entertainment Inc., Tokyo (JP)

(72) Inventors: Tomokazu Kake, Tokyo (JP); Akio Ohba, Kanagawa (JP); Daichi Ono, Kanagawa (JP)

(73) Assignee: Sony Interactive Entertainment Inc., Tokyo (JP)

(21) Appl. No.: 19/115,527

(22) PCT Filed: Nov. 1, 2022
(86) PCT No.: PCT/JP2022/040897

§ 371 Date: Mar. 26, 2025

(51) Int. Cl. G06T 11/60; G06T 7/13; G06T 7/246

(52) U.S. Cl. CPC G06T 11/60; G06T 7/13; G06T 7/246

(57) ABSTRACT

An image processing apparatus acquires input information describing operation input contents and a video on a screen that is displayed according to the operation input, creates at least one digest image by extracting, from each of a plurality of frame pictures constituting the video, partial pictures of positions different from each other, and verifies, on the basis of the digest image, contents of the video corresponding to the operation input contents.

### TECHNICAL FIELD

The present invention relates to an image processing apparatus, an image processing method, and a program for analyzing videos.

### BACKGROUND ART

To test a program of a video game or the like, or to cause a program to execute a certain process without manpower, an operation input such as a keyboard operation that has been conventionally performed by a user can be automatically performed by a computer, and a program can be caused to execute a process according to the automatic operation input. It is to be noted that such an automatic computer input which is a replacement for a user's operation input will be referred to as an automatic input hereinbelow.

### SUMMARY

### Technical Problem

Contents displayed on a screen of a display apparatus in response to an automatic input such as that mentioned above vary according to the program type and the circumstances. For this reason, with a general-purpose method, it has been difficult to verify whether a process corresponding to an automatic input is executed as expected. Different verification means are required to be prepared for individual programs to be verified, automatic input contents, and expected process results, etc. Due to these circumstances, verifying a result of an automatic input is a time-consuming task in general.

The present invention has been made in view of the above circumstances, and an object thereof is to provide an image processing apparatus, an image processing method, and a program by which a program execution result corresponding to an automatic input can be verified in a relatively easy manner.

### Solution to Problem

An image processing apparatus according to one aspect of the present invention includes one or more processors, and the one or more processors acquire input information describing operation input contents and a video on a screen that is displayed according to the operation input, create at least one digest image by extracting, from each of a plurality of frame pictures constituting the video, partial pictures of positions different from each other, and verify, on the basis of the digest image, contents of the video corresponding to the operation input contents.

An image processing method according to one aspect of the present invention includes acquiring input information describing operation input contents and a video on a screen that is displayed according to the operation input, creating at least one digest image by extracting, from each of a plurality of frame pictures constituting the video, partial pictures of positions different from each other, and verifying, on the basis of the digest image, contents of the video corresponding to the operation input contents.

A program according to one aspect of the present invention is a program for causing a computer to execute processes of acquiring input information describing operation input contents and a video on a screen that is displayed according to the operation input, creating at least one digest image by extracting, from each of a plurality of frame pictures constituting the video, partial pictures of positions different from each other, and verifying, on the basis of the digest image, contents of the video corresponding to the operation input contents. The program may be provided in a state of being stored in a computer readable and non-temporal information recording medium.

### BRIEF DESCRIPTION OF DRAWINGS

FIG. 1 is a configuration block diagram depicting a configuration of an image processing apparatus according to an embodiment of the present invention.

FIG. 2 is a functional block diagram of the image processing apparatus according to the embodiment of the present invention.

FIG. 3 is a diagram depicting one example of a configuration of a digest image.

FIG. 4 is a diagram depicting an example of a digest image created on the basis of a target video including a scene transition.

FIG. 5 is a diagram depicting one example of a digest image created on the basis of a target video in which scrolling occurs.

FIG. 6 is a diagram depicting one example of a digest image in a case where an operation target object does not move in an expected manner.

FIG. 7 is a diagram depicting one example in which a position of the operation target object is deviated.

### DESCRIPTION OF EMBODIMENT

Hereinafter, an embodiment of the present invention will be explained in detail with reference to the drawings.

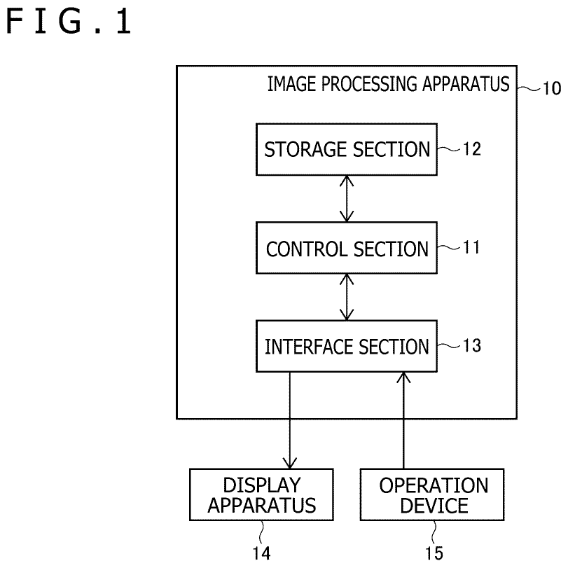

FIG. 1 is a configuration block diagram depicting a configuration of an image processing apparatus 10 according to one embodiment of the present invention. The image processing apparatus 10 is a personal computer or a server computer, for example. As depicted in FIG. 1, the image processing apparatus 10 includes a control section 11, a storage section 12, and an interface section 13. In addition, the image processing apparatus 10 is connected with a display apparatus 14 and an operation device 15.

The control section 11 includes at least one processor such as a central processing unit (CPU) and is configured to execute a variety of information processes by executing a program stored in the storage section 12. It is to be noted that specific examples of the processes that are executed by the control section 11 in the present embodiment will be explained later. The storage section 12 includes at least one memory device such as a random-access memory (RAM). A program to be executed by the control section 11 and data to be processed in the program are stored in the storage section 12.

The interface section 13 is an interface for data communication with the display apparatus 14 and the operation device 15. The image processing apparatus 10 is connected with each of the display apparatus 14 and the operation device 15 via the interface section 13 wired or wirelessly. Specifically, it is assumed that the interface section 13 includes a multimedia interface for transmitting a video signal supplied from the image processing apparatus 10 to the display apparatus 14. Further, the interface section 13 includes a data communication interface for receiving a signal indicating operation contents performed by a user through the operation device 15.

The display apparatus 14 displays, on a screen, a video corresponding to a video signal supplied from the image processing apparatus 10. The operation device 15 is a keyboard, a mouse, or a game controller, for example. The operation device 15 receives operation input contents from a user. The operation device 15 is connected with the image processing apparatus 10 wired or wirelessly and transmits an operation signal indicating the operation input contents received from the user to the image processing apparatus 10.

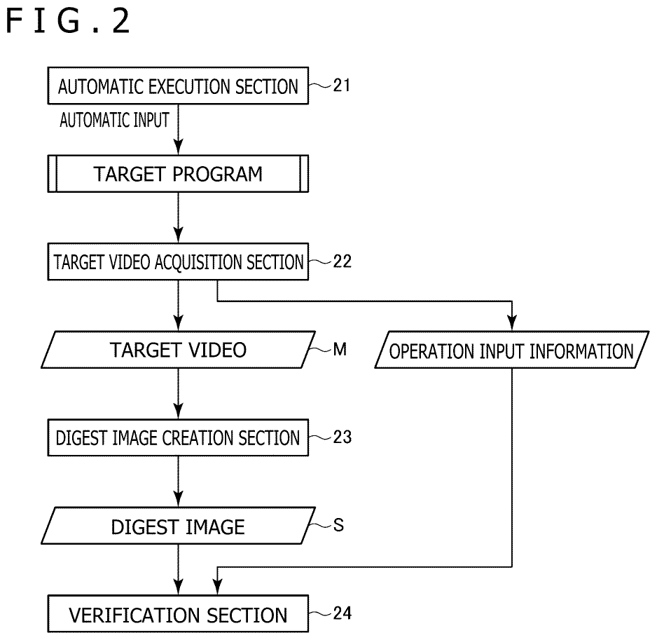

Hereinafter, functions that are implemented by the image processing apparatus 10 will be explained with reference to a functional block diagram in FIG. 2. As depicted in FIG. 2, the image processing apparatus 10 functionally includes an automatic execution section 21, a target video acquisition section 22, a digest image creation section 23, and a verification section 24. These functions are implemented when the control section 11 works in accordance with one or more programs stored in the storage section 12. The programs may be provided to the image processing apparatus 10 via a communication network such as the internet or may be provided by being stored in a computer readable information storage medium such as an optical disk.

The automatic execution section 21 performs an automatic execution of a program (hereinafter, referred to as a target program) to be verified by the image processing apparatus 10 according to the present embodiment. An automatic execution herein refers to executing processing of a target program according to an automatic input. That is, when the target program is under execution, the automatic execution section 21 inputs operation information indicating that a given operation input is performed in place of a user's operation input on the operation device 15, to the target program, so that processing of the target program is executed without a user's manpower.

The target video acquisition section 22 acquires a video to be displayed as a result of the automatic execution of the target program. Hereinafter, such a video is referred to as a target video M. The target video M is rendered by the target program during the automatic execution and is displayed on the screen of the display apparatus 14. By analyzing the contents of the target video M, the image processing apparatus 10 according to the present embodiment verifies a result of the automatic execution. As the target video M, the target video acquisition section 22 may acquire a video recorded during the automatic execution after the automatic execution is completed or may acquire a video being displayed on the display apparatus 14 in real-time while the automatic execution section 21 is performing the automatic execution.

Further, the target video acquisition section 22 acquires automatic input information describing automatic input contents, in addition to the target video M. It is assumed that the automatic input information includes a timing of the automatic input, and information describing the input contents (for example, information indicating depression of a determination key, or information regarding a direction indicated by a direction indicating key).

The digest image creation section 23 creates at least one digest image S expressing the contents of the target video M on the basis of the target video M acquired by the target video acquisition section 22. The digest image S is a still picture created on the basis of a plurality of frame pictures F constituting the target video M. Furthermore, it is assumed that the digest image S has the same size and the same shape as the frame pictures F.

Specifically, the digest image creation section 23 creates the digest image S by extracting a partial picture P from each of the frame pictures F constituting the target video M, and then arranging the extracted partial pictures P. It is assumed that the partial pictures P extracted from the respective frame picture are pictures of different regions, and the positions of the extracted partial pictures P in the digest image S correspond to the respective positions in the original frame pictures F. Accordingly, the digest image S is one still picture that represents a digest of the target video M that is displayed for a certain time period.

In the following specific example, it is assumed that the digest image creation section 23 creates the digest image S by extracting, from each of the frame pictures F, one row of pixels arranged in a horizontal direction as a partial picture P. In a case where the target video M is a 60-fps video and the vertical length of the frame pictures F is 720 pixels, the number of the frame pictures F constituting the target video M for a reproduction time of 12 seconds is 720 (=60 fps×12 seconds), which coincides with the value of the vertical length of each frame picture F (i.e., the number of the partial pictures constituting the digest image S). Hereinafter, the frame pictures F are denoted by F(1), F(2), F(3), . . . F(n), . . . F(720) in order from the top. In addition, the partial picture P extracted from the frame picture F(n) is denoted by P(n).

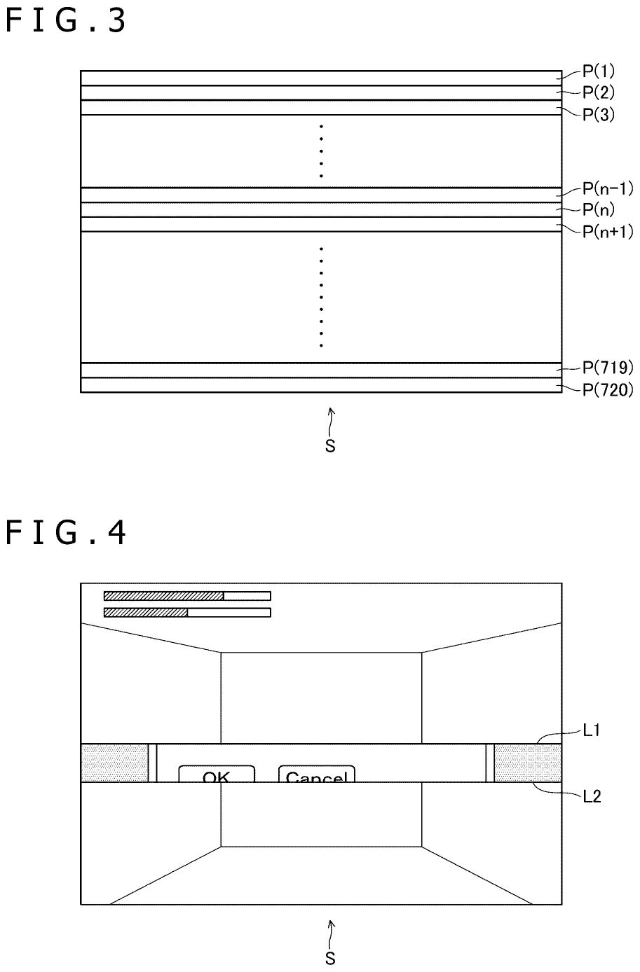

The digest image creation section 23 extracts, as the partial picture P(1), a row of pixels arranged in the horizontal direction on the top of the frame picture F(1). The partial picture P(1) is set as the top pixel row in the digest image S. Further, the second pixel row from the top in the frame picture F(2) is extracted as the partial picture P(2), and is set as the second pixel row from the top in the digest image S. Similarly, the n-th pixel row from the top in the frame picture F(n) is extracted as the partial picture P(n), and is set as the n-th pixel row from the top in the digest image S. This process is repeated for 720 frame pictures F, whereby the digest image S having a vertical length of 720 pixels is created. FIG. 3 schematically depicts the configuration of the digest image S.

The digest image S includes the partial pictures P respectively extracted from 720 frame pictures F and having the same size. The partial pictures P are extracted from different positions in the respective original frame pictures F, and are set, in the digest image S, at the same positions as the positions in the original frame pictures F. Moreover, the partial pictures P are arranged in the same order as the display order of the original frame pictures F. Accordingly, in the digest image S, the partial pictures P extracted from temporarily adjacent frame pictures F are arranged to be spatially adjacent to each other. The digest image S is an image similar to what is called a slit-scan image. In the digest image S, temporal change contents in the target video M are reflected.

By using the digest image S created by the digest image creation section 23, the verification section 24 verifies a result of an automatic execution. Specifically, the verification section 24 analyzes the contents of the digest image S and performs verification of whether a process corresponding to the automatic input has been executed or whether the process result is as expected. For example, by analyzing the digest image S, the verification section 24 verifies whether a temporal change of displayed contents that is estimated according to the automatic input information acquired by the target video acquisition section 22 is actually presented in the target video M. Accordingly, it can be confirmed that a process corresponding to the automatic input is properly executed.

Hereinafter, a few specific examples of verification processes to be executed by the verification section 24 will be explained.

As a first example, a process of verifying a scene transition that occurs according to an automatic input will be explained.

It is assumed that each partial picture P is a pixel row extending in a horizontal direction, as previously explained. Therefore, a boundary between the adjacent partial pictures P is a straight line extending in a horizontal direction. In this example, it is highly likely that a partial picture P extracted from a frame picture F immediately before a timing of occurrence of a scene transition is significantly different in pixel values (e.g., brightness value and density value) from a partial picture P extracted from a frame picture F immediately after the scene transition. For this reason, in the digest image S, a straight edge appears in a position where these partial pictures P are adjacent to each other. In this manner, a line along a boundary between the adjacent partial pictures P is detected from the digest image S. Accordingly, the verification section 24 can identify a timing, during the target video M, at which the entire display content on the screen suddenly changes due to a scene transition or the like.

FIG. 4 depicts one example of the digest image S. FIG. 4 depicts the digest image S created on the basis of the target video M that is displayed during execution of a game program, and depicts an example in which, during display of the target video M, a menu screen having a black background is displayed at a time t1, displaying the menu screen ends, and the original play screen is displayed at a time t2. In positions corresponding to the scene transitions at the time t1 and the time t2, boundaries L1 and L2 appear in the digest image S. Pixel rows above the boundary L1 are extracted from the frame pictures F that are displayed prior to the time t1. Pixel rows between the boundaries L1 and L2 are extracted from the frame pictures F that are displayed from the time t1 to the time t2 (that is, which presents the menu screen). Pixel rows below the boundary L2 are extracted from the frame pictures F that are displayed subsequent to the time t2. It is to be noted that, for convenience of explanation, it is assumed that the displayed contents of the target video M do not change except at timings of the scene transitions at times t1 and t2 in this depicted example. Actually, since the displayed contents vary with time irrespective of a timing of the scene transitions, discontinuous changes over a boundary between the partial pictures P appear in the digest image S. However, as long as there is no drastic change in the overall displayed contents on the screen, the boundaries L1 and L2 as clear as those in FIG. 4 are not expected to appear in any other positions.

By executing image processing on the digest image S, the verification section 24 detects a straight line extending in a horizontal direction (that is, in parallel with a boundary between the partial pictures P). Detection of a line that appears in the image is realized by a known image processing technology such as Hough transformation or edge detection. It is to be noted that, in order to detect such a line, the verification section 24 may first execute preprocessing such as binarization of the digest image S before executing the image processing such as edge detection. Alternatively, the image processing may be executed using any technique such as deep learning.

A line extending along a boundary between the partial pictures P (here, a straight line extending in a horizontal direction) is assumed to correspond to a scene transition in the target video M. Therefore, if the number of such straight lines and the positions thereof are identified whether or not scene transitions have normally occurred can be verified.

Specifically, the verification section 24 verifies whether the number of detected straight lines and the positions thereof match the contents and timing of an automatic input for indicating a scene transition. If the automatic input for indicating a scene transition is performed but occurrence of the scene transition at the corresponding timing is not identified, there is a possibility that the automatic input fails. In particular, in a case where the digest image S is created and a verification process using the created digest image S is performed in real time during the automatic execution, when the verification section 24 cannot detect occurrence of a scene transition, a program executing the automatic input performs control to, for example, re-execute the automatic input for indicating a scene transition. If so, the automatic input may be continued.

Next, a second example will be explained in which whether movement of a displayed element being displayed on the screen and corresponding to an automatic input is as expected is verified. Also in this example, the verification section 24 executes a process of detecting a line (edge) included in the digest image S. However, in this example, a line extending in a direction intersecting a boundary (here, a straight line in a horizontal direction) between the partial pictures P is used, a line to be detected is not limited to straight lines, and a curved line may be detected.

In a specific example, in a case where an automatic input for indicating a direction is performed in a certain time period during reproduction of the target video M and thus displayed contents on the screen are scrolled, displayed elements such as a background and an object displayed on the screen move in the screen. The digest image S includes lines that reflect this movement of the displayed elements. By detecting these lines, the verification section 24 confirms that scrolling is executed as expected.

By way of example, it is assumed that, while a target program is rendering a situation in a virtual space, an automatic input for indicating to move a visual point rightward is performed. If so, the object and the background in the virtual space which have not moved in the virtual space are scrolled leftward in the screen with time. In the digest image S created on the basis of this target video M, a line expressing the contour of a displayed element having moved in the screen appears with distortion in a direction from the upper right to the lower left. That is, a line expressing the displayed element and extending in a direction intersecting a boundary (here, a horizontal line) between the partial pictures P is deformed into a shape inclined toward the movement direction on the digest image S according to the movement of the displayed element in the target video M.

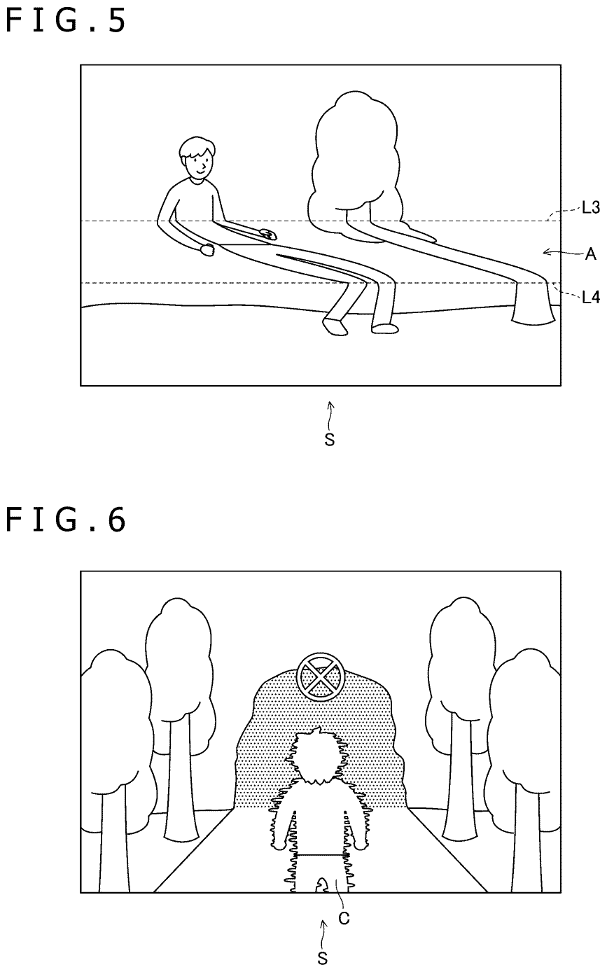

FIG. 5 is a diagram depicting one example of the digest image S and includes a deformed line that appears in the digest image S as a result of the above scrolling. In the example in this drawing, when the target video M is being displayed, a visual point moves leftward in a time period between a time t3 and a time t4. Accordingly, the background and various objects move rightward in the screen. Broken lines L3 and L4 in the drawing represent the boundaries between the partial pictures P corresponding to the times t3 and t4. That is, in the digest image S, the partial pictures P above the broken line L3 are extracted from the frame pictures F that are displayed prior to the time t3, the partial pictures P below the broken line L4 are extracted from the frame pictures F that are displayed subsequent to the time t4, and a region A between the broken lines L3 and LA is composed of the partial pictures P extracted from the frame pictures F that are displayed between the time t3 and the time t4. As depicted in the drawing, in the region A, a line expressing a moved object is deformed further rightward (to the movement direction of the object) on the lower side (a side where the partial picture P extracted from the frame picture F that is displayed at a later timing is arranged).

As in the first example, the verification section 24 detects such a line included in the digest image S and identifies the direction of the line. The direction changes position of the detected line (i.e., position where the line is bent) is identified, whereby a scroll start timing and a scroll end timing can be estimated. This is because lines expressing displayed elements that are under the influence of the scrolling are simultaneously bent at positions over the partial picture boundaries corresponding to the scroll start timing and the scroll end timing. In addition, the direction and speed of the scrolling can be estimated from the bent directions. By confirming whether the timing, the direction, and the speed of the scroll identified on the basis of the digest image S in this manner are as expected, the verification section 24 can verify that a scroll is actually performed according to the automatic input for indicating a scroll.

For example, in a case where an automatic input for indicating visual point movement is performed for three seconds but the occurrence period of a scroll identified by analysis of the digest image S is only two seconds, there is a possibility that the scroll is interrupted during the automatic input. In this case, a user can check the contents of the target video M and look into the cause of the interruption of the scroll. Alternatively, if performing a verification using the digest image S in real time on the basis of the target video M being rendered in real time, the verification section 24 can detect that the scroll is ended because, for example, the limit of the movable range has been reached. When the automatic execution section 21 is notified of the end of the scroll, the automatic execution section 21 can stop the automatic input for indicating movement of the visual point and then start a next automatic input. In the manner described so far, irrespective of the contents of the target program or the displayed contents, control can be performed so as to indicate a direction until a scroll is ended and then start a next automatic input after the end.

A third example will be explained in which whether movement corresponding to an automatic input does not occur is verified. Unlike the foregoing examples, there may be a case where an automatic input expected to cause a change in the screen contents is performed but a large change does not occur on the entire screen. Specifically, there is a case where an object to be operated by a user (hereinafter, referred to as an operation target object) comes to a dead end, for example, and cannot go further, so that any change does not occur in the background on the screen. In this case, an animation change of the operation target object occurs while most of displayed elements in the surrounding area are unchanged for a certain time period. As a result, in the digest image S, discontinuous lines are detected locally in the position where the operation target object is displayed but a line distortion such as that having been explained in the second example does not occur in the surrounding area.

In a case where occurrence of a screen change is expected from the automatic input information but it is determined that the overall screen does not change and a change occurs in a limited region, the verification section 24 infers that the operation target object does not move according to the automatic input.

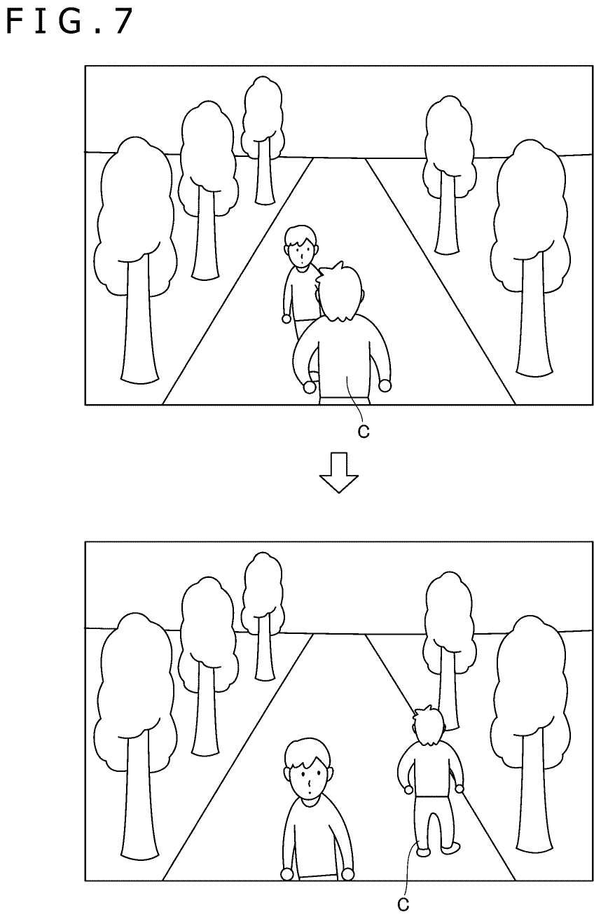

FIG. 6 depicts one example of the digest image S in the above state. FIG. 6 depicts an example of the digest image S in which an entry prohibition region is set in the forward direction of a character C which is an operation target object in a game and the character C is unable to go further for a certain time. From the fact that no change occurs in the surrounding area excluding the character C, it can be determined that the position of the character C in the virtual space is not changed and movement according to the automatic input for indicating movement is not realized.

It is to be noted that, in a case where the forward direction of the character C is different from the direction of a visual point camera when the virtual space is rendered, even if an analysis such as spatial recognition or object recognition of a displayed image is simply performed, there is a possibility that what exists in the forward direction of the character C cannot be identified. In a specific example, in a case where the character C is moving in a direction opposite to the direction of the visual point camera (that is, a direction for approaching the visual point), there is a possibility that an obstacle that exists in the forward direction of the character C is not displayed on the screen because the obstacle is on the front side of the visual point camera. Even in this case, the operation input information and change contents on the screen estimated from the digest image S are compared by the verification method using the digest image S according to the present embodiment, whereby it can be identified that movement corresponding to the operation input does not occur.

In particular, in a case where the verification section 24 performs a verification using the digest image S while the automatic execution is in progress in real time, the automatic execution contents can be corrected according to the state of the operation target object. Specifically, in a case where the automatic execution section 21 receives, from the verification section 24, a notification indicating that movement of the character C does not occur, the automatic execution section 21 may change the automatic execution to indicate movement to a direction (e.g., opposite direction) different from the currently indicated direction. Even when the automatic execution results in an unexpected state, this control restores a normal state so that the automatic execution can be continued.

In addition, the verification section 24 may verify that the operation target object moves in a manner that is not expected. By way of example, in a case where the operation target object moves under the influence of the surrounding area such as contact with an obstacle, the movement is different from movement corresponding to the indication included in the automatic input information. FIG. 7 is a diagram depicting one example of this movement, and depicts a scene in the target video M. In the example in this drawing, the position of the character C which is the operation target object is deviated to the right side due to contact with another character who is in the forward direction. If such a deviation is out of expectation, the automatic execution cannot be normally continued in some cases.

Therefore, the verification section 24 detects this movement of the operation target object on the basis of a change in a displayed element such as the background included in the digest image S. Then, movement that is different from movement corresponding to the indication specified by the automatic input information is detected, a notification regarding the movement is provided to the automatic execution section 21. The automatic execution section 21 executes the automatic input for indicating movement to cancel the detected movement. Specifically, in a case where, for example, unexpected rightward movement of the operation target object is detected, the automatic input for moving the operation target object leftward by the same amount is executed. Accordingly, even in a case where an unexpected deviation occurs in a moving process of an object, a normal state can be restored.

The verification section 24 may execute the abovementioned verification processes in combination. Also, contents to be verified may be changed in accordance with the contents of the automatic input information. For example, in a case where an automatic input for indicating a scene transition is performed, a process of detecting a scene transition corresponding to the automatic input is performed, and when an automatic input for indicating movement of the operation target object is being performed, a process of verifying the movement process is performed.

Furthermore, according to the result of this verification, the verification section 24 may execute the next verification. For example, in a case where the automatic execution section 21 automatically executes a sequence process of giving a scene switching instruction and then giving a movement instruction for an operation target object, the verification section 24 first identifies a timing at which scene switching corresponding to the scene switching instruction occurs by analyzing the digest image S. Then, a portion of the digest image S corresponding to a time later than the scene switching timing (that is, a portion below the boundary the partial pictures P indicating the scene transition timing) is subjected to a verification process of verifying movement contents of the operation target object. According to this process, not the entire digest image S but only a portion corresponding to a verification object is subjected to the verification process, whereby the required computation amount can be reduced. In addition, even in a case where a timing of occurrence of the automatic input is previously unknown, automatic execution contents corresponding to a series of scenarios can be sequentially verified. In particular, in a case where a verification is performed in real time while the automatic execution is in progress, the automatic execution section 21 may decide the contents of a next automatic execution according to the verification result. In this case, the next automatic execution can be started after an expected result is confirmed, or control to correct the automatic execution contents can be performed if the result is not an expected one, as previously explained. Thus, automatic execution including a plurality of steps or automatic execution which may lead to a different result due to a slight timing shift can be executed with high accuracy.

It is to be noted that the foregoing explanation describes an example regarding a verification of the target video M for one digest image S. However, the verification section 24 may create a plurality of the digest images S from one target video M, and may execute a verification process on each of the digest images S. For example, in the foregoing explanation, the size of the digest image S is the same size as the frame pictures F constituting the target video M. Therefore, the number of the partial pictures P that can be included in the digest image S is restrained by the size of the frame pictures F. For this reason, the number of the frame pictures F constituting the target video M for which the digest image S is to be created also depends on the size of the frame pictures F. In a case where a verification process is executed for the target video M including the frame pictures F that are more than the partial pictures P included in one digest image S, the digest image creation section 23 divides a reproduction time of the target video M into multiple periods, and creates the digest image S for each of the divided periods. The verification section 24 executes the abovementioned verification process on each of the digest images S thus created, so that the entire target video M can be verified.

In a specific example, in a case where the target video M is a 60-fps video having a vertical size of 720 pixels, 720 frame pictures F for 12 seconds can form one digest image S. Therefore, when the automatic execution is in progress, the digest image creation section 23 creates one digest image S on the basis of the frame pictures F for 12 seconds each time 12 seconds elapse from the start time point of the automatic execution. Each time one digest image S is created, the verification section 24 analyzes and verifies the created digest image S.

However, when the digest images S are created for individual time periods that do not overlap each other, there is a possibility that some objects to be verified are overlooked. In the above example, for example, the first digest image S is created for 12 seconds from the start time point of the automatic execution. However, the partial pictures P are extracted from the lower half part of the frame pictures F for 6 to 12 seconds after the start time point. Therefore, in this time period, a change occurring in the upper half part of the target video M is not reflected in the digest image S.

To this end, the digest image creation section 23 may create the digest images S for overlapping time periods. In one example, at every 6 seconds after the start time point of the abovementioned automatic execution, the digest image creation section 23 may create the digest image S using the frame pictures F corresponding to 12 seconds. In this case, from the target video M which is a 60-seconds video, the digest images S starting from the elapsed times of 0 second, 6 seconds, 12 seconds, 18 seconds, . . . are sequentially created. Each of these digest images S is created for a time period including 6 seconds common to the next digest image S. For the common time period, the partial pictures P are extracted from the regions different from those of the next digest image S. Accordingly, displayed contents in the target video M can be verified more comprehensively. It is to be noted that a half of the time period for one digest image S overlaps the time period of another digest image S in the foregoing example, but a longer time period may overlap with that of another digest image S. If so, more digest images S are created.

In the foregoing explanation, each partial picture P is one pixel row extending in a horizontal direction, and the digest image S is assumed to be a still picture in which the partial pictures P are arranged in a vertical direction and has the same size as the original frame pictures F. However, the sizes and shapes of the digest image S and the partial pictures P constituting the digest image S are not limited to those mentioned above, and any size and shape can be adopted therefor.

Specifically, one partial picture P includes one row of pixels arranged along a horizontal direction in the above explanation, but each partial picture P may be a region including n (n is an integer of 1 or more) pixel rows. Furthermore, each partial picture P may be a picture of a region including one or more pixel rows extending not in a horizontal direction but in a vertical direction. In this case, the boundary between the partial pictures P is a straight line extending in a vertical direction. Alternatively, the partial picture P may be a pixel row extending in a diagonal direction.

For example, in a case where the target video M is a game video to be scrolled vertically, an object and a background of the target video M change mainly in a vertical direction. This change is difficult to be expressed in the digest image S constituting of the partial pictures P extending in a horizontal direction, and is considered to be more clearly expressed in the digest image S if the digest image S is formed by arranging the vertically extending partial pictures P in a horizontal direction. Therefore, the digest image creation section 23 may select the shape and direction of the partial pictures P according to which direction a change of an object or a background occurs in the target video M. In general, when the partial pictures P are arranged so as to be side by side along a direction intersecting the direction of a screen change, the screen change can be easily verified using the digest image S.

In addition, the digest image creation section 23 may create a plurality of the digest images S that are different in arrangement directions from each other, and the verification section 24 may execute a verification process on each of the digest images S. Accordingly, changes in many different directions can be verified.

In addition, the partial pictures P do not necessarily have the same size and the same shape. By way of example, the digest image S may be formed by arranging the partial pictures P having different diameters concentrically.

Furthermore, the digest image creation section 23 may create the digest image S for a partial region of the target video M. For example, in a case where a region for displaying a parameter or the like of a game character is disposed along the upper side of the target video M, a sudden temporal change is unlikely to occur in this region where an object does not move. Therefore, the remaining region may be set as an attention region, and the partial pictures P may be extracted from the attention region to create the digest image S. In addition, in a case where a relatively large change is expected to occur in a region near the center portion of the screen in the target video M, a region excluding the outer periphery may be set as an attention region, and then, the digest image S may be created therefor. In this example, the size of the created digest image S is not the same as the size of the frame pictures F constituting the target video M, and the size and shape of the digest image S are the same as the size and shape of the attention region.

The attention region is not required to be rectangle and may have any shape such as a trapezoidal shape. Further in this case, the digest image creation section 23 may alter the shape of the partial picture P extracted from the attention region in each frame picture F by, for example, affine transformation to create the digest image S. Accordingly, the partial pictures P each extracted from an attention region having a trapezoidal shape or the like may be combined so that the digest image S of a rectangular shape can be created.

As explained so far, the digest image S is created for an attention region having a given shape at a given position in the target video M, whereby the digest image S expressing a temporal change in a region to receive more attention can be created. In particular, a range within which the operation target object can move or a region to be scrolled according to an automatic input is set as an attention region so that the contents of the automatic input contents can be efficiently verified. It is to be noted that, also in this example, the partial pictures P extracted from the temporally adjacent frame pictures F are arranged to be spatially adjacent to each other in the digest image S so that the verification section 24 can execute the verification process of, for example, detecting a scene transition by using the digest image S.

In addition, the digest image creation section 23 may create the respective digest images S for different attention regions. For example, the digest image S for the upper half part of the target video M and the digest image S for the lower half part may be separately created. It is considered that, if the verification section 24 executes the verification process on each of the created digest images S, a display abnormality occurring within a local range is likely to be detected.

In addition, by using a technology such as NeRF (Neural Radiance Fields) which is used to create a free viewpoint image in a three-dimensional space, the digest image creation section 23 may determine the shape and size of an attention region from which the partial pictures P are extracted, and determine how to transform the partial pictures P and arrange the partial pictures P in the digest image S. If a plurality of the frame pictures F formed in two-dimensional planes are arranged in parallel in the depth direction, a three-dimensional space of coordinate axes (x, y, and t) can be formed. In this space, x and y respectively indicate the coordinate axes in a horizontal direction and a vertical direction of each frame picture F while t indicates a time axis. The digest image S corresponds to an image obtained by projecting such a three-dimensional space onto a given projection plane. Therefore, the digest image creation section 23 may decide how to set the projection plane using a technology of rendering a state in a three-dimensional space. Accordingly, the digest image S in which movement of an object in the target video M is more clearly expressed can be created.

As explained so far, by analysis of the digest image S, the image processing apparatus 10 according to the present embodiment can relatively efficiently verify contents displayed by the target program according to an automatic input. In addition, in the foregoing verification process using the digest image S, requirements that depend on the type of a target program, the contents of displayed images, the contents of an automatic execution, the shape of an operation target object, etc. are relatively few. Therefore, when a variety of kinds of programs are automatically executed, the process is easily applicable for general purposes, and it is highly likely that a result of an automatic execution can be verified without separately determining a specific verification condition or the like.

It is to be noted that the embodiment of the present invention is not limited to those explained above. By way of example, the shapes and sizes of the partial pictures P extracted from the respective frame pictures F are the same in the foregoing explanation, but the sizes of the partial pictures P may vary. For example, in a part for a time period including a drastic screen change in the target video M, the digest image creation section 23 sets the width of the partial pictures P (that is, the size in the direction in which the partial pictures P are arranged) to be small, and, in a part for a time period including a relatively small screen change, the digest image creation section 23 sets the width of the partial pictures P to be large. Accordingly, the digest image S can be created in which, in a part for a time period including a drastic change, the change is more elaborately reflected. In addition, the digest image creation section 23 may vary the shapes and sizes of the partial pictures P in accordance with the automatic input information. By way of example, the size of the partial pictures P may be set to be relatively large for a time period in which no automatic input is executed, and the size of the partial pictures P may be set to be relatively small for a time period in which an automatic input is executed. Accordingly, the digest image S can be created in which, in a part for a time period where a screen content change is expected, the change is more elaborately reflected.

In the foregoing explanation, the position of the partial picture P extracted from one frame picture F is determined so as not to overlap the positions of the partial pictures P extracted from the other frame pictures F. The present invention is not limited to this, and each partial picture P may be arranged so as to partially overlap the adjacent partial picture P in the digest image S. By way of example, in a case where each partial picture P includes three pixel rows extending in a horizontal direction and arranged in a vertical direction, the digest image creation section 23 may arrange the partial pictures P in such a way that the top one of the three pixel rows overlaps the lowest pixel row of the partial picture P extracted from the preceding frame picture F and the lowest pixel row overlaps the top pixel row of the partial picture P extracted from the following frame picture F. In this case, in a position where two adjacent partial pictures P overlap, these adjacent partial pictures P are made translucent and superimposed, for example. Accordingly, the digest image S in which a smoother change is expressed can be created.

In the foregoing explanation, the image processing apparatus 10 according to the present embodiment executes the target program to be verified by the image processing apparatus 10. However, the target program may be executed by a separate computer that is communicably connected with the image processing apparatus 10. In this case, the automatic execution section 21 realizes automatic execution of the target program by outputting the automatic input contents to the computer executing the target program. In addition, the automatic execution may also be realized by the separate computer, and the image processing apparatus 10 may acquire the automatic input information and the target video M from the computer.

In the foregoing explanation, the target video M is a video on a screen rendered by the target program according to the automatic input. However, the target video M is not limited to this type. The target video M may be a video on a screen rendered according to a user's manual operation input. Also in this case, the verification section 24 can verify whether a process corresponding to the operation input is correctly performed, by comparing operation input information describing the user's manual operation input contents and an analysis result of the digest image S.

Furthermore, in a case where an analysis of the digest image S for a video on the screen displayed according to a user's manual operation input is conducted in real time, the result of the analysis can be fed back to the user so that the user is prompted to correct the user's operation contents. For example, in a case where the verification section 24 detects occurrence of a deviation of the movement path of the operation target object from operation input contents as in the abovementioned example in FIG. 6, the verification section 24 notifies the user of detection of the deviation. Specifically, the verification section 24 notifies the user of detection of the deviation by, for example, indicating a certain message on a display apparatus separate from the display apparatus 14 displaying the video to be verified, by reproducing a prescribed sound or by causing vibration of a vibration mechanism incorporated in the operation device 15. In this case, the verification section 24 may vary the notification contents according to the direction or amount of the detected deviation. For example, as the amount of the detected deviation is larger, the operation device 15 may be more strongly vibrated.

In addition, the verification section 24 may provide a notification using any other device connected to the image processing apparatus 10. For example, in a case where the image processing apparatus 10 is connected to a lighting device, the verification section 24 may provide a notification regarding detection of the deviation by causing the lighting device to flash. More specifically, when detecting the deviation of the movement path of the operation target object from a user's operation input, the verification section 24 may change the color of emission light of the lighting device according to the direction of the deviation, and may further change the flashing speed according to the amount of the deviation. If this lighting device is installed near the screen of the display apparatus 14, the user can be informed of occurrence of an unexpected behavior without imparting influence on contents displayed on the screen of the display apparatus 14 or the sounds.

In particular, when the user is performing a debugging operation of the target program, the user is required to continue a certain operation input while paying attention to a debug screen and other points in a displayed video. In such a situation, the user may overlook an unexpected behavior of the operation target object or have difficulty in performing an operation for correcting the deviation. Therefore, detection of the deviation is notified by, for example, causing the lighting device to flash so that the user can definitely discern such an unexpected situation.

Moreover, when detecting a deviation of the operation target object, the verification section 24 may monitor whether an operation input for correcting the deviation is performed and may inform a user of the result. For example, in a case where a deviation of the operation target object to the right side by a prescribed amount during an upward movement operation is detected, an operation for moving the operation target object to an opposite side (here, the left side) by the same amount is required. Therefore, the verification section 24 notifies the user that the deviation to the right side has occurred by performing control to, for example, change the color of the lighting device. In a case where it is determined that the deviation is corrected as a result of the user's operation for moving the operation target object leftward, the verification section 24 performs control to restore the original color of the lighting device. Accordingly, even if the user cannot gaze at the operation target object on the screen due to a debugging operation or the like, the user can perform a deviation canceling operation correctly.

What is claimed is:

1. An image processing apparatus comprising:
one or more processors, wherein the one or more processors:
acquire input information describing operation input contents and a video on a screen that is displayed according to the operation input,
create at least one digest image by extracting, from each of a plurality of frame pictures constituting the video, partial pictures of positions different from each other, and
verify, on a basis of the digest image, contents of the video corresponding to the operation input contents.

2. The image processing apparatus according to claim 1, wherein the one or more processors detect a line included in the digest image, and verifies the contents of the video on a basis of the detected line.

3. The image processing apparatus according to claim 2, wherein the one or more processors verify a scene transition corresponding to the operation input for indicating scene switching by detecting a line extending in a direction along a boundary between the partial pictures.

4. The image processing apparatus according to claim 2, wherein the one or more processors verify a direction and/or an amount of a screen change corresponding to the operation input by detecting a line extending in a direction intersecting a boundary between the partial pictures.

5. The image processing apparatus according to claim 2, wherein the one or more processors verify movement contents of a target object of the operation input by detecting a line extending in a direction intersecting a boundary between the partial pictures.

6. The image processing apparatus according to claim 1, wherein the one or more processors automatically perform a predetermined operation input to a target program to acquire input information describing the operation input contents and a video of images displayed by the target program according to the operation input, and
determine contents of the next operation input contents according to a verification result of the contents of the video.

7. An image processing method comprising:
acquiring input information describing operation input contents and a video on a screen that is displayed according to the operation input;
creating at least one digest image by extracting, from each of a plurality of frame pictures constituting the video, partial pictures of positions different from each other; and
verifying, on a basis of the digest image, contents of the video corresponding to the operation input contents.

8. A program for a computer, comprising:
by one or more processors,
acquiring input information describing operation input contents and a video on a screen that is displayed according to the operation input;
creating at least one digest image by extracting, from each of a plurality of frame pictures constituting the video, partial pictures of positions different from each other; and
verifying, on a basis of the digest image, contents of the video corresponding to the operation input contents.
